(19) United States
(12) Patent Application Publication
(10) Pub. No.: US 2025/0159093 A1
(43) Pub. Date: May 15, 2025

(54) COMMUNICATION SYSTEM, NON-TRANSITORY COMPUTER READABLE MEDIUM, AND COMMUNICATION METHOD

(71) Applicant: FUJIFILM Business Innovation Corp., Tokyo (JP)

(72) Inventor: Yoshinori Ando, Kanagawa (JP)

(73) Assignee: FUJIFILM Business Innovation Corp., Tokyo (JP)

(21) Appl. No.: 18/650,370

(22) Filed: Apr. 30, 2024

(30) Foreign Application Priority Data
Nov. 13, 2023 (JP) 2023-193226

(51) Int. Cl. H04N 1/32; H04N 1/00

(52) U.S. Cl. CPC H04N 1/32641; H04N 1/00037

(57) ABSTRACT

A communication system includes a processor configured to communicate, when an abnormality has occurred in communication based on a first communication method, with a first communication system that is communicable using communication based on a second communication method, and cause the first communication system to transmit a piece of information to a target of communication using communication based on the first communication method.

### CROSS-REFERENCE TO RELATED APPLICATIONS

This application is based on and claims priority under 35 USC 119 from Japanese Patent Application No. 2023-193226 filed Nov. 13, 2023.

### BACKGROUND

### (i) Technical Field

The present disclosure relates to a communication system, a non-transitory computer readable medium, and a communication method.

### (ii) Related Art

For example, Japanese Unexamined Patent Application Publication No. 2021-114173 discloses an information processing apparatus including: first activation means that activates a first software module in response to activation of a boot program; first verification means that verifies tampering with a second software module when the first software module is activated; update means that overwrites, when it is determined that the second software module has been tampered with, backup data for the second software module instead of overwriting the second software module to update the second software module; second verification means that verifies tampering with the updated second software module; and second activation means that activates, when it is determined that the updated second software module has not been tampered with, the updated second software module.

### SUMMARY

Aspects of non-limiting embodiments of the present disclosure relate to provision of a communication system that, when, in the communication system that transmits a piece of information to a target of communication using a first communication method, an abnormality has occurred in communication based on the first communication method, makes it possible to transmit the piece of information to the target of communication.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a communication system including a processor configured to communicate, when an abnormality has occurred in communication based on a first communication method, with a first communication system that is communicable using communication based on a second communication method, and cause the first communication system to transmit a piece of information to a target of communication using communication based on the first communication method.

### BRIEF DESCRIPTION OF THE DRAWINGS

An exemplary embodiment of the present disclosure will be described in detail based on the following figures, wherein:

FIG. 1 is a front cross-sectional diagram illustrating an image forming apparatus according to an exemplary embodiment of the present disclosure;

FIG. 2 is a block diagram illustrating a functional configuration of a control portion according to the exemplary embodiment of the present disclosure;

FIG. 3 is a diagram illustrating a state in which the image forming apparatuses according to the exemplary embodiment of the present disclosure are coupled to a network;

FIG. 4 is a diagram illustrating data included in transmission request data according to the exemplary embodiment of the present disclosure;

FIG. 5 is a diagram illustrating data included in proxy transmission data according to the exemplary embodiment of the present disclosure;

FIG. 6 is a flowchart illustrating a procedure that the image forming apparatus according to the exemplary embodiment of the present disclosure executes;

FIG. 7 is a sequence diagram illustrating a procedure in which the image forming apparatus according to the exemplary embodiment of the present disclosure causes another image forming apparatus to transmit image data to an image forming apparatus that is a target of communication; and

FIG. 8 is a sequence diagram illustrating a procedure in which an image forming apparatus according to the exemplary embodiment of the present disclosure causes another image forming apparatus and still another image forming apparatus to attempt to transmit image data to an image forming apparatus that is a target of communication.

### DETAILED DESCRIPTION

Hereinafter, an example of an exemplary embodiment of the present disclosure will be described with reference to the drawings. Note that, in the drawings, the same or equivalent components and parts are denoted by the same reference signs. Furthermore, dimensional ratios in the drawings are exaggerated for convenience of description and may be different from actual ratios.

Note that, in the following description, a user refers to a person using an image forming apparatus 10 or an image forming apparatus 11, and a number of the persons is not limited. Furthermore, in the following description, a plurality of users may be described without distinction.

### (Image Forming Apparatus 10)

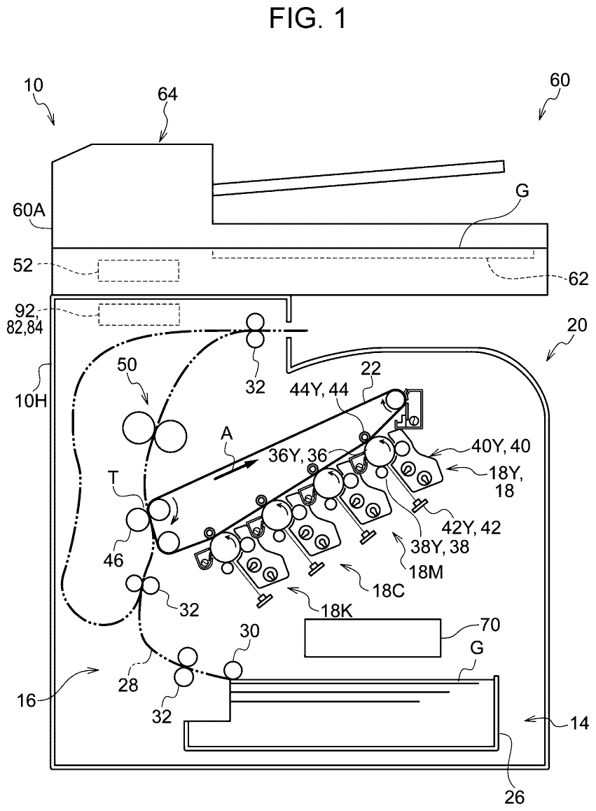

The image forming apparatus 10 illustrated in FIG. 1 is an example of an “image forming system” according to the present exemplary embodiment. The image forming apparatus 10 is a so-called multifunction printer (MFP), and has a function of receiving a print job and forming an image on a document G, and a function of reading an image from a document G as image data. Furthermore, the image forming apparatus 10 further has a mail function of attaching, to an electronic mail, and transmitting image data to another image forming apparatus 10, and a facsimile function of using a line for a facsimile to transmit the image data. As illustrated in FIG. 1, the image forming apparatus 10 includes, from bottom to top, an image forming portion 20 that forms an image on a document G and a document reading portion 60 that reads an image formed on a document G. Furthermore, the image forming apparatus 10 includes a control portion 70 that controls the image forming portion 20 and the document reading portion 60, and a touch panel 92 that displays a state of the image forming apparatus 10. Note that the document G is an example of a “recording medium” according to the present exemplary embodiment. (Image Forming Portion 20)

The image forming portion 20 includes image forming units 18, an accommodation portion 14, and a conveyance portion 16. The image forming units 18, the accommodation portion 14, and the conveyance portion 16 are stored in a housing 10H of the image forming apparatus 10.

The image forming portion 20 includes four image forming units 18Y, 18M, 18C, and 18K for yellow (Y), magenta (M), cyan (C), and black (K), respectively. Note that, in the following description, when it is not necessary to distinguish Y, M, C, and K from each other for description, Y, M, C, and K may be omitted.

It is possible to attach and detach the image forming units 18 for the colors to and from the housing 10H, respectively. Then, the image forming units 18 for the colors each include an image holding body 36, a charging roll 38 that causes a surface of the image holding body 36 to be charged, and an exposure device 42 that causes the image holding body 36 that has been charged to be irradiated with exposure light. In addition, the image forming units 18 for the colors are each provided with a developing device 40 that develops and visualizes, as a toner image, an electrostatic latent image formed as the exposure device 42 described above has caused the image holding body 36 that has been charged to be exposed with exposure light.

Furthermore, the image forming portion 20 includes a transfer belt 22 that has an endless shape and that rotates in a direction of an arrow A in FIG. 1, and primary transfer rolls 44 that transfer toner images formed by the image forming units 18 for the colors to the transfer belt 22. In addition, the image forming portion 20 includes secondary transfer rolls 46 that transfer the toner images transferred to the transfer belt 22 to a document G, and a fixing device 50 that heats and pressurizes the document G to which the toner images have been transferred to fix the toner images to the document G.

The primary transfer rolls 44 cause the toner images formed on the surfaces of the image holding bodies 36 for the colors to be transferred to the transfer belt 22. Furthermore, the toner images on a surface of the transfer belt 22 are transferred to the document G at a transfer position T.

The accommodation portion 14 is provided with an accommodation member 26 that is able to be withdrawn from the housing 10H of the image forming apparatus 10 toward a front side in a depth direction of the apparatus, and documents G are stacked in the accommodation member 26. In addition, the accommodation portion 14 is provided with a sending roll 30 that sends a top one of the documents G loaded in the accommodation member 26 to a conveyance path 28 configuring the conveyance portion 16.

The conveyance portion 16 includes a plurality of conveying rolls 32 that convey a document G along the conveyance path 28. The document G sent from the accommodation member 26 to the conveyance path 28 by the sending rolls 30 is sent to the transfer position T where the transfer belt 22 and the secondary transfer rolls 46 are in contact with each other. As the document G is conveyed between the transfer belt 22 and one of the secondary transfer rolls 46, the toner images are transferred to the document G.

The fixing device 50 causes the toner images transferred to the document G to be fixed to the document G. Then, the conveying rolls 32 cause the document G on which the toner images have been fixed to be discharged to outside of the housing 10H.

### (Touch Panel 92)

The touch panel 92 is a device that displays a state of the image forming apparatus 10 and the like based on control of the control portion 70, and is an example of an “indicating portion” according to the present exemplary embodiment. The touch panel 92 is possible to indicate a state of the image forming apparatus 10 and to receive an operation by the user, and functions as a user interface of the image forming apparatus 10. That is, the touch panel 92 according to the present exemplary embodiment functions as both a “display portion 82” and a “reception portion 84” according to the present exemplary embodiment. Furthermore and in other words, the touch panel 92 is also an example of a part of an “information processing system” according to the present exemplary embodiment. Note that the touch panel 92 may be disposed at a desired position, but, as illustrated in FIG. 1, as an example, is disposed on a front surface of the housing 10H of the image forming apparatus 10.

Note that a configuration and specific functions of the control portion 70 included in the image forming apparatus 10 will be described later.

### (Document Reading Portion 60)

The document reading portion 60 is an example of a reading device according to the present exemplary embodiment, and includes a transparent plate 62 (so-called platen glass) on which, when an image on a single document G is to be read, the document G is placed. Then, the transparent plate 62 is fitted into an upper portion of a housing 60A of the document reading portion 60.

An opening-and-closing cover for opening or closing the transparent plate 62 is disposed above the transparent plate 62. Then, inside the opening-and-closing cover, a conveyance device 64 (a so-called auto document feeder (ADF) device) that conveys a plurality of documents G along the conveyance path 28 inside the opening-and-closing cover is provided.

Furthermore, inside the housing 60A, an image reading device 52 that reads an image on a document G placed on the transparent plate 62 and that reads an image on a document G conveyed to a document reading position R by the conveyance device 64 is provided. The document reading portion 60 reads an image on a document G and generates image data based on control of the control portion 70. Note that the read image on the document G is stored as image data in a random access memory (RAM) 72C that will be described later. That is, a combination of the control portion 70 and the document reading portion 60 is an example of a “document reading system” according to the present exemplary embodiment.

### (Control Portion 70)

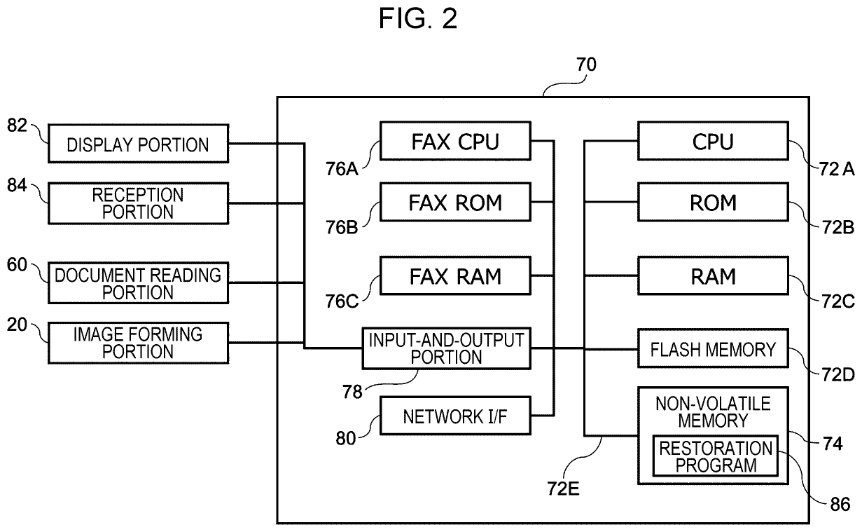

The control portion 70 is an example of the “information processing system” according to the present exemplary embodiment, and, as illustrated in FIG. 2, includes a central processing unit (CPU) 72A and the RAM 72C used as a temporary working region for the CPU 72A. Note that the CPU 72A is an example of a “processor” according to the present exemplary embodiment. Furthermore, the control portion 70 includes a read only memory (ROM) 72B, a flash memory 72D, a non-volatile memory 74 that stores a control program causing the control portion 70 to function, and an input-and-output portion 78. Furthermore, the control portion 70 according to the present exemplary embodiment further includes a facsimile CPU 76A, a facsimile ROM 76B, and a facsimile RAM 76C. These various components are coupled to the input-and-output portion 78 and a network interface (hereinafter referred to as a “network I/F 80”) via a bus 72E.

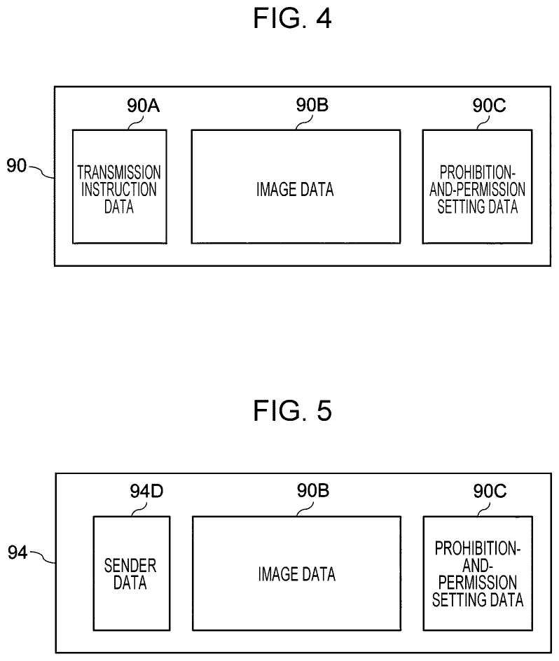

Note that the RAM 72C may store transmission request data 90 and proxy transmission data 94 in a procedure of replacing a program, which will be described later (see also FIGS. 4 and 5).

Furthermore, the CPU 72A in the control portion 70 reads the control program that is an example of a “program” according to the present exemplary embodiment from the ROM 72B, and executes entire control of the image forming apparatus 10 borne by the control portion 70. Specifically, as illustrated in FIG. 2, the touch panel 92, the document reading portion 60, and the image forming portion 20 included in the image forming apparatus 10 are coupled to the input-and-output portion 78 in the control portion 70. Thereby, the CPU 72A in the control portion 70 controls the components including the touch panel 92, the document reading portion 60, and the image forming portion 20.

The non-volatile memory 74 is an example of a storage device in which stored information is maintained even when power supplied to the components is cut off, for which a semiconductor memory is used, but a hard disk may be used, for example. Furthermore, a restoration program 86 that will be described later is recorded in the non-volatile memory 74.

The facsimile CPU 76A, the facsimile ROM 76B, and the facsimile RAM 76C are identical in specific configuration to the CPU 72A, the ROM 72B, and the RAM 72C, respectively. When the CPU 72A transmits image data stored in the RAM 72C to another apparatus, the facsimile CPU 76A serves as a facsimile to play a role of transmitting the image data as image information to the other apparatus via the line for the facsimile (e.g., a facsimile line). Furthermore, a communication method using the line for the facsimile in the present exemplary embodiment is an example of a “first communication method” according to the present exemplary embodiment.

More specifically, when an instruction has been received from the CPU 72A, the facsimile CPU 76A reads a program for transmitting image data from the facsimile ROM 76B through the line for the facsimile, uses the line for the facsimile, and transmits the image data to another apparatus.

Note that, if there is an abnormality in the program that the facsimile CPU 76A executes (for example, if the program has been tampered), the CPU 72A transfers the restoration program 86 stored in the non-volatile memory 74 to the facsimile ROM 76B. Thereby, the CPU 72A replaces the program recorded in the facsimile ROM 76B with the restoration program 86 to restore the facsimile function. (Network Coupling)

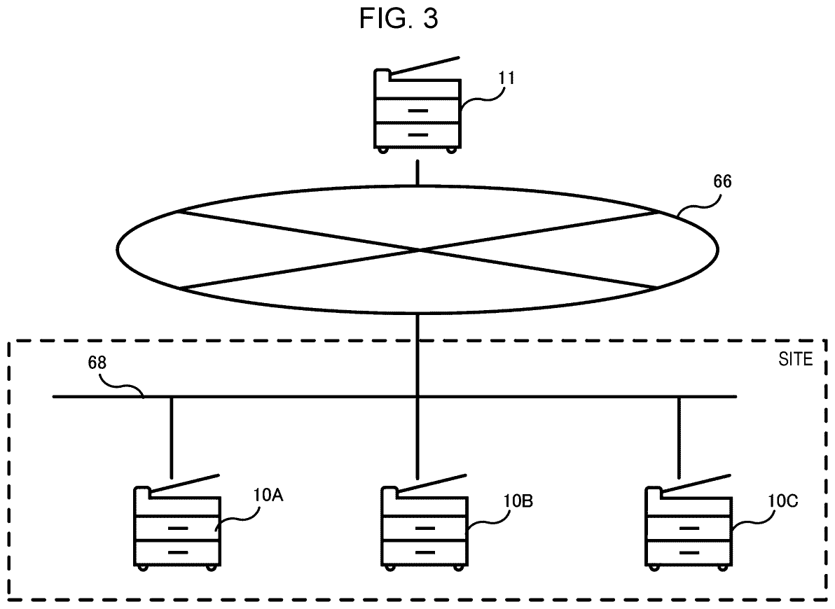

A plurality of the image forming apparatuses 10 according to the present exemplary embodiment are disposed in a site as illustrated in FIG. 3. More specifically, the plurality of image forming apparatuses 10 disposed in the site are coupled to each other via an internal network 68 such as a local area network (LAN), and, furthermore, the image forming apparatuses 10 are each coupled to a network 66. Note that, in the following description, a specific one of the image forming apparatuses 10 may be referred to as an “apparatus itself”, and another one of the image forming apparatuses 10, which is different from the apparatus itself, may be referred to as “another apparatus”. That is, the “apparatus itself” and the “other apparatus” are examples of a “system itself” and “another system” according to the present exemplary embodiment, respectively. Note that, in the following description, when the image forming apparatuses 10 disposed in the site are distinguished from each other, A, B, or C is added to ends of the reference signs to distinguish the image forming apparatuses from each other. Furthermore, in the following description, an image forming apparatus 10A is referred to as an “apparatus itself”, and an image forming apparatus 10B and an image forming apparatus 10C are referred to as “other apparatuses”.

Furthermore, as illustrated in FIG. 3, the image forming apparatus 10A, the image forming apparatus 10B, and the image forming apparatus 10C disposed in the site are able to communicate with each other through the internal network 68. Furthermore, a communication method using the internal network 68 in the present exemplary embodiment is an example of a “second communication method” according to the present exemplary embodiment.

Note that, as illustrated in FIG. 3, the image forming apparatus 11 that is a target of communication is an example of a “target of communication” according to the present exemplary embodiment, which is disposed in a network that is different from the network in the site where the apparatus itself is disposed. More specifically, the image forming apparatus 11 that is the target of communication is an image forming apparatus equivalent to the apparatus itself, but is disposed in a small-scale network that is different from the network in the site where the apparatus itself and the other apparatuses are disposed. The image forming apparatus 11 that is the target of communication is coupled to the network 66 using the facsimile line, as an example.

Then, the image forming apparatus 10A, the image forming apparatus 10B, and the image forming apparatus 10C are able to each communicate with the image forming apparatus 11 using the facsimile line. To be more specific, the image forming apparatus 10A, the image forming apparatus 10B, and the image forming apparatus 10C communicate with the image forming apparatus 11 that is the target of communication using the facsimile function.

Furthermore, the image forming apparatus 10A according to the present exemplary embodiment is able to transmit the transmission request data 90 illustrated in FIG. 4 as an example to another apparatus via the internal network 68. Note herein that, as illustrated in FIG. 4, the transmission request data 90 includes transmission instruction data 90A, image data 90B, and prohibition-and-permission setting data 90C. The transmission instruction data 90A is data including an instruction to transmit the image data 90B and the prohibition-and-permission setting data 90C included in the transmission request data 90 received from any one of the other apparatuses to the image forming apparatus 10 or the image forming apparatus 11 that is a transmission destination using the facsimile line. The image data 90B is data that the apparatus itself has attempted to transmit to the transmission destination, and is an image on a document G, which the document reading portion 60 has read, and which is to be transmitted from the apparatus itself to the transmission destination. The prohibition-and-permission setting data 90C is data including an instruction to prohibit communication with the image forming apparatus 10 that has transmitted the transmission request data 90, that is, the apparatus itself, or to permit communication with the apparatus itself. Note that the image data 90B is an example of a piece of “information” according to the present exemplary embodiment.

Furthermore, when the transmission request data 90 has been received, the image forming apparatus 10 according to the present exemplary embodiment creates proxy transmission data 94 illustrated in FIG. 5, which is to be transmitted to the image forming apparatus 10 that is the transmission destination, which is included in the transmission instruction data 90A included in the transmission request data 90.

As illustrated in FIG. 5, the proxy transmission data 94 includes the image data 90B, the prohibition-and-permission setting data 90C, and sender data 94D. The sender data 94D is data including a destination for the image forming apparatus 10 that has transmitted the transmission request data 90. Then, the image forming apparatus 10 transmits the proxy transmission data 94 that has been created using the facsimile line.

Furthermore, when the proxy transmission data 94 has been received, the image forming apparatus 10 and the image forming apparatus 11 according to the present exemplary embodiment set, based on the prohibition-and-permission setting data 90C, prohibition or permission for the image forming apparatus 10 that has transmitted the transmission request data 90. More specifically, the CPU 72A prohibits or permits communication using the facsimile line when the proxy transmission data 94 has been received. For example, when the prohibition-and-permission setting data 90C has included information that prohibits communication with the image forming apparatus 10 that has transmitted the transmission request data 90 using the facsimile line, the CPU 72A is prohibited to communicate with the image forming apparatus 10 using the facsimile line. Furthermore, for example, when the prohibition-and-permission setting data 90C has included information that permits communication with the image forming apparatus 10 that has transmitted the transmission request data 90 using the facsimile line, the CPU 72A is permitted to communicate with the image forming apparatus 10 using the facsimile line.

Note that a desired method may be used to prohibit communication with the image forming apparatus 10 using the facsimile line. As examples, the touch panel 92 may display that communication with the image forming apparatus 10 is prohibited, and, furthermore, such a setting may be made that a transmission error is displayed when the user has attempted to communicate with the image forming apparatus 10. Furthermore, in an aspect, when the prohibition-and-permission setting data 90C has been received, the CPU 72A in the image forming apparatus 10 may print information included in the prohibition-and-permission setting data 90C to provide a notification to the user using the image forming apparatus 10. That is, in the present exemplary embodiment, prohibiting communication and permitting communication include both a case where the CPU 72A in the image forming apparatus 10 prohibits communication and a case where communication with the user is prohibited and permitted.

Note that, when, in a state where communication with the image forming apparatus 10 using the facsimile line is prohibited, information that permits communication with the image forming apparatus 10 using the facsimile line, which has transmitted the transmission request data 90, is further included, the prohibition is not cancelled. Furthermore, when, in a state where communication with the image forming apparatus 10 using the facsimile line is permitted, information that permits communication with the image forming apparatus 10 using the facsimile line, which has transmitted the transmission request data 90, is further included, the permission is not cancelled.

Note that, in the above description, examples of the destination include, in addition to a network address when using the internal network 68, a facsimile number (a so-called telephone number) when using the facsimile line.

### (Abnormality in Facsimile Transmission Program)

Incidentally, when an abnormality has occurred due to reasons such as unauthorized access to the program that the facsimile CPU 76A executes in the image forming apparatus 10A that is the apparatus itself, the control portion 70 is unable to transmit the image data 90B using the facsimile line. Note that a case where an abnormality has occurred in the program that the facsimile CPU 76A executes is an example of a “case where an abnormality has occurred in communication based on the first communication method” according to the present exemplary embodiment.

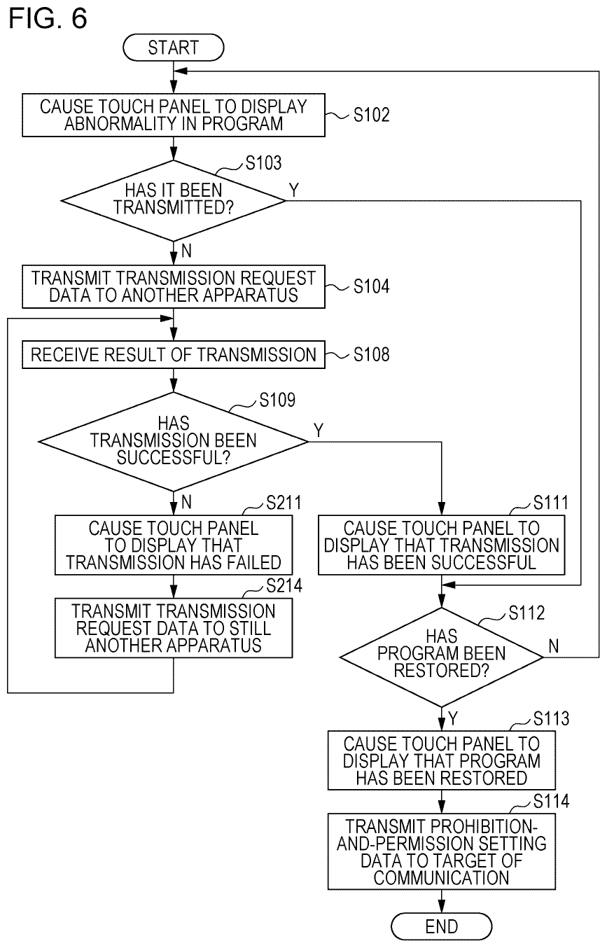

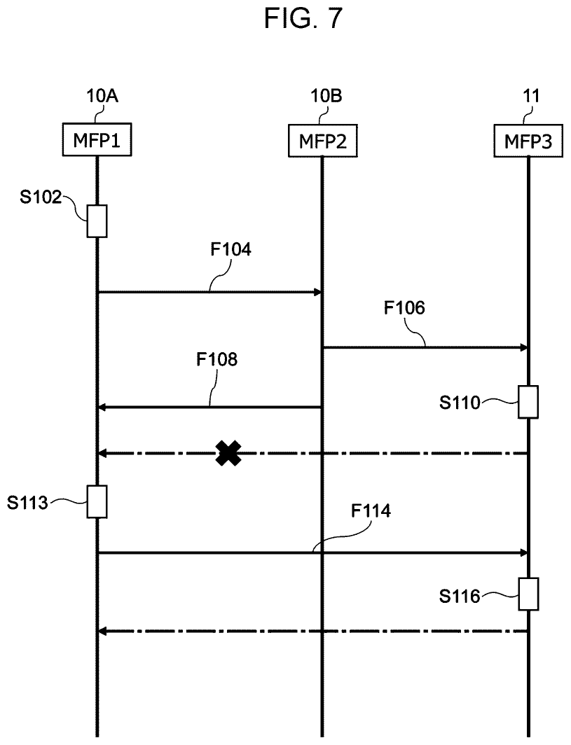

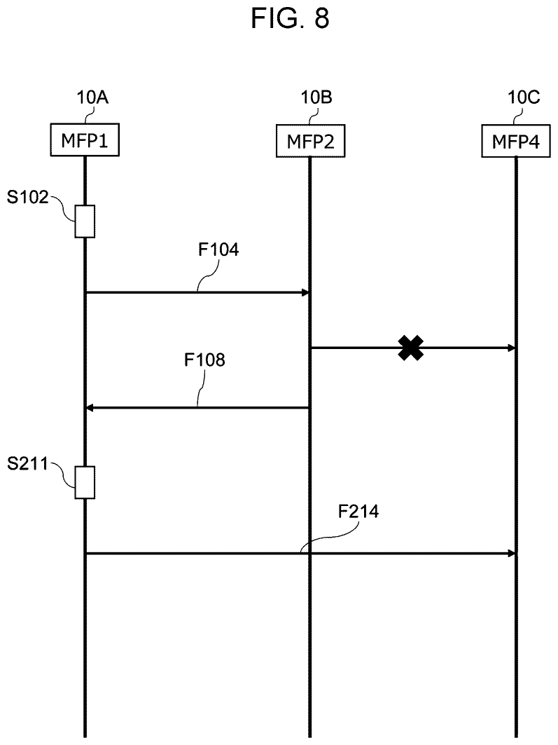

Note herein that, when an abnormality has occurred in the program that the facsimile CPU 76A executes, the CPU 72A in the image forming apparatus 10A according to the present exemplary embodiment transmits the image data 90B based on a procedure illustrated in FIG. 6. In other words, when an abnormality has occurred in communication based on the first communication method, the CPU 72A executes the procedure illustrated in FIG. 6. Furthermore, FIGS. 7 and 8 illustrate situations where the CPU 72A in the image forming apparatus 10A executes the procedure illustrated in FIG. 6 to communicate with the image forming apparatus 10B, the image forming apparatus 10C, and the image forming apparatus 11.

Note that, for steps denoted by identical reference signs in FIGS. 6 to 8, it is regarded that identical steps in the procedure are to be executed in FIGS. 6 to 8.

### (Procedure for Causing Another Apparatus to Transmit Image Data 90B to Image Forming Apparatus 11)

In step S102, the CPU 72A in the image forming apparatus 10A first causes the touch panel 92 to display that there is an abnormality in the program that the facsimile CPU 76A executes. Note that, in the present description, it is assumed that, in step S102, the CPU 72A has failed to complete restoration of the program that the facsimile CPU 76A executes.

Next, in step S103, the CPU 72A in the image forming apparatus 10A determines whether or not the image data 90B has been transmitted to the image forming apparatus 11 using the line for the facsimile. Then, when a positive determination is made in step S103, the CPU 72A in the image forming apparatus 10A proceeds to step S112. Furthermore, when a negative determination is made in step S103, the CPU 72A in the image forming apparatus 10A proceeds to step S104.

Next, in step S104, the CPU 72A in the image forming apparatus 10A transmits, to the image forming apparatus 10B, through the internal network 68, a request for the image forming apparatus 10B to transmit image data to the image forming apparatus 11 using the line for the facsimile. More specifically, in sequence F104, as illustrated in FIG. 7, the CPU 72A in the image forming apparatus 10A transmits, to the image forming apparatus 10B, the image data 90B and the transmission request data 90 for the image forming apparatus 11 for the image data 90B using the facsimile line. Note that the prohibition-and-permission setting data 90C in the transmission request data 90 includes information that prohibits communication with the image forming apparatus 10A.

Next, in step S108, the CPU 72A in the image forming apparatus 10A waits until a result of the transmission is returned from the image forming apparatus 10B. More specifically, the CPU 72A waits until a notification pertaining to sequence F108 described later is provided from the image forming apparatus 10B.

Next, in sequence F106, the CPU 72A in the image forming apparatus 10B transmits the image data 90B to the image forming apparatus 11 using the facsimile line based on the request under the transmission request data 90 received from the image forming apparatus 10A. More specifically, the CPU 72A in the image forming apparatus 10B transmits the proxy transmission data 94 to the image forming apparatus 11 in sequence F106.

Furthermore, in sequence F108, the CPU 72A in the image forming apparatus 10B notifies the image forming apparatus 10A of a result of the communication with the image forming apparatus 11 using the facsimile line. More specifically, in FIG. 7, the CPU 72A in the image forming apparatus 10B notifies the image forming apparatus 10A that the communication with the image forming apparatus 11 has been successful.

Then, when the notification pertaining to sequence F108 has been received from the image forming apparatus 10B in step S108, the CPU 72A in the image forming apparatus 10A proceeds to step S109.

As described above, the image forming apparatus 11 according to the present exemplary embodiment receives the proxy transmission data 94 from the image forming apparatus 10B and thus receives the image data 90B from the image forming apparatus 10B that has transmitted the proxy transmission data 94.

Furthermore, in step S110, the CPU 72A in the image forming apparatus 11 prohibits communication with the image forming apparatus 10A based on the prohibition-and-permission setting data 90C included in the proxy transmission data 94 received in sequence F106. Thereby, in and after step S110, the user is prohibited from performing communication from the image forming apparatus 11 to the image forming apparatus 10A.

Note that, in step S109, when the result of the communication, which has been received in sequence F108, is a success result, the CPU 72A in the image forming apparatus 10A proceeds to step S111. Furthermore, when the result of the communication, which has been received in sequence F108, is a failure result, the CPU 72A in the image forming apparatus 10A proceeds to step S211.

Next, in step S111, the CPU 72A in the image forming apparatus 10A causes the touch panel 92 to display that the transmission of the image data 90B to the image forming apparatus 11 has been successful. Then, the CPU 72A in the image forming apparatus 10A proceeds to step S112.

Note that the CPU 72A in the image forming apparatus 10A attempts, in step S112, to restore the program that the facsimile CPU 76A executes and determines whether or not the restoration has been completed, and then, when a positive determination is made in step S112, the CPU 72A in the image forming apparatus 10A proceeds to step S113. Furthermore, when a negative determination is made in step S103, the CPU 72A in the image forming apparatus 10A proceeds to step S102.

Next, in step S113, the CPU 72A in the image forming apparatus 10A causes the touch panel 92 to display that the program that the facsimile CPU 76A executes has been restored, and proceeds to step S114.

Next, in step S114, the CPU 72A in the image forming apparatus 10A permits the image forming apparatus 11 to communicate with the apparatus itself. More specifically, in sequence F114, as illustrated in FIG. 7, the CPU 72A in the image forming apparatus 10A transmits, to the image forming apparatus 11, the prohibition-and-permission setting data 90C including information that permits communication with the image forming apparatus 10A.

Furthermore, in step S116, the CPU 72A in the image forming apparatus 11 permits communication with the image forming apparatus 10A based on the prohibition-and-permission setting data 90C received in sequence F114. Thereby, in and after step S116, the user is permitted to perform communication from the image forming apparatus 11 to the image forming apparatus 10A.

Through the procedure described above, the image forming apparatus 10A according to the present exemplary embodiment communicates, when an abnormality has occurred in communication based on the facsimile line, with the image forming apparatus 10B that is communicable using communication based on the internal network 68. Then, the image forming apparatus 10A causes the image forming apparatus 11 to transmit the image data 90B using the facsimile line. That is, the image forming apparatus 10B is an example of a “first communication system” according to the present exemplary embodiment. Furthermore, the image forming apparatus 11 is an example of the “target of communication” according to the present exemplary embodiment. Furthermore, a case where there is an abnormality in the program that the facsimile CPU 76A in the image forming apparatus 10A executes is an example of the “case where an abnormality has occurred in communication based on the first communication method” according to the present exemplary embodiment. Furthermore, causing the image forming apparatus 10B to transmit the proxy transmission data 94 to the image forming apparatus 11 is an example of “causing the first communication system to transmit a piece of information to a target of communication using communication based on the first communication method” according to the present exemplary embodiment. That is, a case where the image forming apparatus 10A transmits the transmission request data 90 to the image forming apparatus 10B is an example of “communicating with the first communication system that is communicable using communication based on the second communication method, and causing the first communication system to transmit a piece of information to a target of communication using communication based on the first communication method” according to the present exemplary embodiment.

Furthermore, a procedure when transmission of the image data 90B has failed, more specifically, a procedure when a negative determination is made in sequence S109 in FIG. 6, which is illustrated in FIG. 7, will be described with reference to FIG. 8. In other words, the CPU 72A executes a procedure illustrated in FIG. 8 when an abnormality has occurred in communication based on the first communication method and the procedure illustrated in FIG. 7 has failed.

### (Procedure for Causing Still Another Apparatus to Transmit Image Data 90B to Image Forming Apparatus 11)

It is first assumed that the CPU 72A in the image forming apparatus 10B has attempted to transmit the image data 90B to the image forming apparatus 11 using the facsimile line based on the request received from the image forming apparatus 10A in sequence F104, but has failed to transmit the image data to the image forming apparatus 11. In this case, in sequence F108, the CPU 72A in the image forming apparatus 10B notifies the image forming apparatus 10A of a result of the communication with the image forming apparatus 11 using the facsimile line. More specifically, in sequence F108, the CPU 72A in the image forming apparatus 10B notifies the image forming apparatus 10A that the communication with the image forming apparatus 11 has failed. Thereby, the CPU 72A in the image forming apparatus 10A makes a negative determination in step S109 in FIG. 6, and proceeds to sequence S211.

Then, in step S211, the CPU 72A in the image forming apparatus 10A causes the touch panel 92 to display that the transmission of the image data 90B to the image forming apparatus 11 has failed. Furthermore, the CPU 72A in the image forming apparatus 10A proceeds to step S214.

Next, in step S214, the CPU 72A in the image forming apparatus 10A transmits, to another image forming apparatus 10, a request to transmit image data to the image forming apparatus 11, through the internal network 68. More specifically, in sequence F214 illustrated in FIG. 8, the CPU 72A in the image forming apparatus 10A transmits, to the image forming apparatus 10C, through the internal network 68, a request for the image forming apparatus 10C to transmit image data to the image forming apparatus 11 using the line for the facsimile. Furthermore and in other words, in sequence F214, the CPU 72A in the image forming apparatus 10A transmits, to the image forming apparatus 10C, the image data 90B and the transmission request data 90 for the image forming apparatus 11 for the image data 90B as a piece of information to be transmitted using the facsimile line.

Note that the CPU 72A in the image forming apparatus 10A executes sequence F214 in step S214, and then proceeds to step S108.

Furthermore, subsequent sequences in the procedure, which the CPU 72A in the image forming apparatus 10C executes, are identical to sequence F104 and onward in the procedure in FIG. 7. In other words, when it is determined in step S109 that the image forming apparatus 10B has failed to communicate with the image forming apparatus 11, the CPU 72A in the image forming apparatus 10A causes another image forming apparatus 10 to transmit the image data 90B to the image forming apparatus 11 anew. Furthermore and in other words, sequence F214 illustrated in FIG. 8 corresponds to sequence F104 illustrated in FIG. 7.

The CPU 72A in the image forming apparatus 10A according to the present exemplary embodiment causes, through the procedure described above, when transmission of the image data 90B to the image forming apparatus 11 has failed, the image forming apparatus 10B to transmit a failure result that is a result of the transmission to the image forming apparatus 10A. Furthermore, when the failure result has been received from the image forming apparatus 10B, the CPU 72A in the image forming apparatus 10A causes the image forming apparatus 10C to transmit the image data 90B to the image forming apparatus 11. That is, the image forming apparatus 10C is an example of a “second communication system” according to the present exemplary embodiment. Furthermore, a case where the image forming apparatus 10B transmits the proxy transmission data 94 to the image forming apparatus 11 is an example of “causing the first communication system to transmit a piece of information to a target of communication using communication based on the first communication method” according to the present exemplary embodiment That is, a case where the image forming apparatus 10A transmits the transmission request data 90 to the image forming apparatus 10C is an example of “communicating with the second communication system that is communicable using the second communication method, and causing the second communication system to transmit a piece of information to a target of communication using communication based on the first communication method” according to the present exemplary embodiment.

Next, workings and effects of the image forming apparatus 10 according to the present exemplary embodiment will now be described herein.

### (Workings and Effects)

The control portion 70 in the image forming apparatus 10 according to the present exemplary embodiment communicates, when there is an abnormality in communication based on the facsimile line, with the image forming apparatus 10B that is communicable using communication based on the internal network 68. Then, the control portion 70 causes the image forming apparatus 10B to transmit a piece of information to the image forming apparatus 11 using communication based on the facsimile line. Thereby, the image forming apparatus 10 is able to transmit the image data 90B to the image forming apparatus 11 using the facsimile line, even when an abnormality has occurred in the facsimile transmission program for communication system.

Furthermore, the control portion 70 according to the present exemplary embodiment prohibits transmission of another piece of information from the image forming apparatus 11 to the image forming apparatus 10A. Thereby, the control portion 70 is able to cause the user using the image forming apparatus 11 to prohibit an unnecessary attempt to communicate with the image forming apparatus 10A.

Furthermore, the control portion 70 according to the present exemplary embodiment permits transmission of another piece of information from the image forming apparatus 11 to the image forming apparatus 10A when the abnormality in communication based on the facsimile line in the image forming apparatus 10A has been solved. Thereby, the control portion 70 is able to allow the user using the image forming apparatus 11 to start again communication from the image forming apparatus 11 to the image forming apparatus 10A.

Furthermore, the control portion 70 according to the present exemplary embodiment causes the image forming apparatus 10B to transmit, to the image forming apparatus 10A, a result of the transmission of the image data 90B to the image forming apparatus 11. Thereby, the control portion 70 is able to notify the user using the image forming apparatus 10A of a result of the transmission of the image data 90B to the image forming apparatus 11.

Furthermore, the control portion 70 according to the present exemplary embodiment causes, when the image data 90B has been successfully transmitted to the image forming apparatus 11, the image forming apparatus 10B to transmit a success result that is a result of the transmission to the image forming apparatus 10A. Thereby, the control portion 70 is able to notify the user using the image forming apparatus 10A that the image data 90B has been transmitted to the image forming apparatus 11.

Furthermore, the control portion 70 in the image forming apparatus 10A according to the present exemplary embodiment causes, when transmission of the image data 90B to the image forming apparatus 11 has failed, the image forming apparatus 10B to transmit a failure result that is a result of the transmission to the image forming apparatus 10A. Thereby, the control portion 70 is able to notify the user using the image forming apparatus 10A that transmission of a piece of information to the image forming apparatus 11 has failed.

Furthermore, the control portion 70 in the image forming apparatus 10A according to the present exemplary embodiment communicates, when the failure result has been received from the image forming apparatus 10B, with the image forming apparatus 10C that is communicable using communication based on the internal network 68. Then, the CPU 72A in the control portion 70 causes the image forming apparatus 10C to transmit the image data 90B to the image forming apparatus 11 using communication based on the facsimile line. Thereby, even when an abnormality has occurred in communication based on the facsimile line by the image forming apparatus 10B, the control portion 70 is able to leave a possibility that a piece of information is to be transmitted to the image forming apparatus 11.

Furthermore, the control portion 70 according to the present exemplary embodiment further includes the touch panel 92, and causes, when an abnormality has occurred, the touch panel 92 to display that the abnormality has occurred. Thereby, the control portion 70 is able to notify the user using the image forming apparatus 10A of the abnormality in the facsimile line for the image forming apparatus 10A.

Furthermore, the image forming apparatus 10 according to the present exemplary embodiment includes the control portion 70 and the document reading portion 60 that reads an image recorded on a document G, and the image data 90B includes the image data 90B that the document reading portion 60 has read. Thereby, the image forming apparatus 10 is able to transmit an image recorded on a document G to the image forming apparatus 11 even when an abnormality has occurred in the facsimile line for the image forming apparatus 10A.

Furthermore, the image forming apparatus 10 according to the present exemplary embodiment includes the control portion 70, the document reading portion 60, and the image forming portion 20 that forms an image on the document G. Thereby, the image forming apparatus 10 is able to transmit an image recorded on a document G to the image forming apparatus 11 even when an abnormality has occurred in the facsimile line for the image forming apparatus 10 transmitting the image data 90B of the image recorded on the document G to the image forming apparatus 11 using the facsimile line.

Furthermore, the control program that the CPU 72A according to the present exemplary embodiment executes causes communication with the image forming apparatus 10B that is communicable using the internal network 68 to be performed, when an abnormality has occurred in communication based on the facsimile line. Then, the control portion 70 causes the image forming apparatus 10B to transmit a piece of information to the image forming apparatus 11 using communication based on the facsimile line. Thereby, the image forming apparatus 10 is able to acquire a program that allows transmission of the image data 90B to the image forming apparatus 11 using the facsimile line, even when an abnormality has occurred in the facsimile transmission program for communication system.

### Modification Examples

Note that, although, in the above description, the CPU 72A has transmitted the transmission request data 90 including the prohibition-and-permission setting data 90C in sequence F104, the technique according to the present exemplary embodiment is not limited to the description. For example, the transmission request data 90 may not include the prohibition-and-permission setting data 90C.

Furthermore, although, in the above description, the CPU 72A has transmitted the prohibition-and-permission setting data 90C to the image forming apparatus 11 in sequence F114, when an abnormality in the facsimile line has been solved, the technique according to the present disclosure is not limited to the description. For example, processing of permitting communication from the image forming apparatus 11 to the image forming apparatus 10A may be achieved as the user using the image forming apparatus 11 directly operates the image forming apparatus 11.

Furthermore, although, in the above description, the CPU 72A has caused the image forming apparatus 10B to notify the image forming apparatus 10A of a result of transmission of the image data 90B to the image forming apparatus 11, the technique according to the present disclosure is not limited to the description. That is, the CPU 72A in the image forming apparatus 10A may not cause the image forming apparatus 10B to execute sequences F108 and F208.

Furthermore, although, in the above description, the CPU 72A has caused the touch panel 92 to display that there is an abnormality in the program in step S102, the technique according to the present exemplary embodiment is not limited to the description. For example, in step S102, the CPU 72A may not cause the touch panel 92 to display that there an abnormality in the program.

Furthermore, although, in the above description, the CPU 72A has caused the touch panel 92 to display that transmission of the image data 90B to the image forming apparatus 11 has been successful or has failed in steps S111 and S211, the technique according to the present exemplary embodiment is not limited to the description. For example, instead of displaying on the touch panel 92, an image indicating that transmission of the image data 90B has been successful or has failed may be printed on a document G.

Furthermore, although, in the above description, the CPU 72A has caused the touch panel 92 to display that the program has been restored from the abnormality in step S113, the technique according to the present exemplary embodiment is not limited to the description. For example, in step S113, the CPU 72A may not cause the touch panel 92 to display that the program has been restored.

Furthermore, although, in the above description, the CPU 72A has transmitted the transmission request data 90 to the image forming apparatus 10C when a failure result has been received in sequence F208, the technique according to the present exemplary embodiment is not limited to the description. For example, the CPU 72 may end a series of the procedure without executing sequence F214. In this case, the CPU 72A may cause the touch panel 92 to display that the image data 90B has not been successfully transmitted.

Furthermore, a failure result notified in sequence F208 in the above description may include a reason of why the image forming apparatus 10B has failed to transmit the proxy transmission data 94 (a so-called error code). In this case, the CPU 72A in the image forming apparatus 10A may determine whether or not to execute sequence F214 in accordance with the reason. For example, when the image forming apparatus 11 is in a processing operation including execution of a print job or the like when viewed from the image forming apparatus 10B, the CPU 72A may transmit the transmission request data 90 to the image forming apparatus 10B again after a predetermined time has elapsed.

Even in these modification examples, it is possible to acquire identical workings and effects to those described above.

### Other Modification Examples

Note that, although, in the above description, the control portion 70 included in the image forming apparatus 10 has been described as an example of an information system, the technique according to the present exemplary embodiment is not limited to the description. That is, as to the control portion 70, it is possible to apply the technique according to the present exemplary embodiment in a similar manner to a combination of the control portion 70 and the document reading portion 60 without including the image forming portion 20.

Furthermore, although, in the above description, the touch panel 92 has been presented as an example of the indicating portion, the technique according to the present disclosure is not limited to the description. For example, instead of a device having a screen such as the touch panel 92, an indication may be provided using a lighting device such as a rotating light or an indication may be provided using an acoustic device such as a buzzer, when it is detected that an abnormality has occurred in a program.

Furthermore, although, in the above description, the image forming portion 20 has formed a toner image on a document G, the technique according to the present disclosure is not limited to the description. For example, an inkjet method may be used to allow the image forming portion 20 to form an image on a document G.

Furthermore, although, in the above description, the CPU 72 in the image forming apparatus 10A has directly communicated with the image forming apparatus 10B or the image forming apparatus 10C, the technique according to the present disclosure is not limited to the description. For example, the CPU 72 in the image forming apparatus 10A may cause the image forming apparatus 10B to communicate with the image forming apparatus 10C. In other words, the CPU 72 in the image forming apparatus 10A may cause the image forming apparatus 10B to transmit the transmission request data 90 to the image forming apparatus 10C, when communication with the image forming apparatus 11 using the facsimile line has failed. That is, the image forming apparatus 10A may transmit the image data 90B to the image forming apparatus 11 by causing the plurality of image forming apparatuses 10 to relay the transmission request data 90.

While the exemplary embodiment of the present disclosure has been described with reference to the accompanying drawings, it is apparent that those skilled in the art to which the present disclosure pertains can conceive various modifications and applications within the scope of the technical idea described in the claims, and it is to be understood that these naturally belong to the technical scope of the present disclosure.

### Appendix

(((1)))

A communication system including a processor configured to
communicate, when an abnormality has occurred in communication based on a first communication method, with a first communication system that is communicable using communication based on a second communication method; and
cause the first communication system to transmit a piece of information to a target of communication using communication based on the first communication method.
   (((2)))

The communication system according to (((1))), in which the processor is configured to prohibit transmission of an other piece of information from the target of communication to the communication system.

(((3)))

The communication system according to (((2))), in which the processor is configured to permit, when the abnormality in the communication based on the first communication method in the communication system has been solved, transmission of the other piece of information from the target of communication to the communication system.

(((4)))

The communication system according to any one of (((1)) to (((3))), in which the processor is configured to cause the first communication system to transmit, to the communication system, a result of the transmission of the piece of information to the target of communication.

(((5)))

The communication system according to (((4))), in which the processor is configured to cause, when the piece of information has been successfully transmitted to the target of communication, the first communication system to transmit a success result that is the result of the transmission to the communication system.

(((6)))

The communication system according to (((4))) or (((5))), in which the processor is configured to cause, when transmission of the piece of information to the target of communication has failed, the first communication system to transmit a failure result that is the result of the transmission to the communication system.

(((7)))

The communication system according to (((6))), in which the processor is configured to communicate, when the failure result has been received from the first communication system, with a second communication system that is communicable using the second communication method, and cause the second communication system to transmit the piece of information to the target of communication using communication based on the first communication method.

(((8)))

The communication system according to any one of (((1)) to (((7))), further including an indicating portion,
in which the processor is configured to cause, when the abnormality has occurred, the indicating portion to indicate that the abnormality has occurred.
   (((9)))

The communication system according to (((1))), further including a reading device configured to read an image recorded on a recording medium,
in which the piece of information includes image data that the reading device has read.
   (((10)))

The communication system according to (((9))), further including an image forming portion configured to form an image on a recording medium.

(((11)))

A program causing a computer to execute a process including:
communicating, when an abnormality has occurred in communication based on a first communication method, with a first communication system that is communicable using communication based on a second communication method; and
causing the first communication system to transmit a piece of information to a target of communication using communication based on the first communication method.
   (((12)))

A communication method including:
communicating, when an abnormality has occurred in communication based on a first communication method, with a first communication system that is communicable using communication based on a second communication method; and
causing the first communication system to transmit a piece of information to a target of communication using communication based on the first communication method.

What is claimed is:

1. A communication system comprising a processor configured to:
communicate, when an abnormality has occurred in communication based on a first communication method, with a first communication system that is communicable using communication based on a second communication method; and
cause the first communication system to transmit a piece of information to a target of communication using communication based on the first communication method.

2. The communication system according to claim 1, wherein the processor is configured to prohibits transmission of an other piece of information from the target of communication to the communication system.

3. The communication system according to claim 2, wherein the processor is configured to permit, when the abnormality in the communication based on the first communication method in the communication system has been solved, transmission of the other piece of information from the target of communication to the communication system.

4. The communication system according to claim 1, wherein the processor is configured to cause the first communication system to transmit, to the communication system, a result of the transmission of the piece of information to the target of communication.

5. The communication system according to claim 4, wherein the processor is configured to cause, when the piece of information has been successfully transmitted to the target of communication, the first communication system to transmit a success result that is the result of the transmission to the communication system.

6. The communication system according to claim 4, wherein, the processor is configured to cause, when transmission of the piece of information to the target of communication has failed, the first communication system to transmit a failure result that is the result of the transmission to the communication system.

7. The communication system according to claim 5, wherein the processor is configured to cause, when transmission of the piece of information to the target of communication has failed, the first communication system to transmit a failure result that is the result of the transmission to the communication system.

8. The communication system according to claim 6, wherein the processor is configured to communicate, when the failure result has been received from the first communication system, with a second communication system that is communicable using the second communication method, and cause the second communication system to transmit the piece of information to the target of communication using communication based on the first communication method.

9. The communication system according to claim 7, wherein the processor is configured to communicate, when the failure result has been received from the first communication system, with a second communication system that is communicable using the second communication method, and cause the second communication system to transmit the piece of information to the target of communication using communication based on the first communication method.

10. The communication system according to claim 1, further comprising an indicating portion,
wherein the processor is configured to cause, when the abnormality has occurred, the indicating portion to indicate that the abnormality has occurred.

11. The communication system according to claim 1, further comprising a reading device configured to read an image recorded on a recording medium,
wherein the piece of information includes image data that the reading device has read.

12. The communication system according to claim 11, further comprising an image forming portion configured to form an image on a recording medium.

13. A non-transitory computer-readable storage medium storing a program causing a computer to execute a process comprising:
communicating, when an abnormality has occurred in communication based on a first communication method, with a first communication system that is communicable using communication based on a second communication method; and
causing the first communication system to transmit a piece of information to a target of communication using communication based on the first communication method.

14. A communication method comprising:
communicating, when an abnormality has occurred in communication based on a first communication method, with a first communication system that is communicable using communication based on a second communication method; and
causing the first communication system to transmit a piece of information to a target of communication using communication based on the first communication method.
